(19) United States
(12) Patent Application Publication
(10) Pub. No.: US 2017/0088759 A1
(43) Pub. Date: Mar. 30, 2017

(54) METHOD AND APPARATUS FOR PRODUCING ALUMINA MONOHYDRATE AND SOL GEL ABRASIVE GRAIN

(71) Applicant: Shengguo WANG, Shanghai (CN)

(72) Inventor: Shengguo WANG, Shanghai (CN)

(21) Appl. No.: 15/312,917

(22) PCT Filed: May 25, 2014
(86) PCT No.: PCT/CN2014/078359

§ 371 Date: Nov. 21, 2016

(51) Int. Cl. C09K 3/14; B01J 19/02; C04B 35/624; C04B 35/626; C01F 7/44; C04B 35/10

(52) U.S. Cl. CPC C09K 3/1409; C01F 7/447; C09K 3/1436; C04B 35/10; C04B 35/624; C04B 35/62645; B01J 19/02; C04B 2235/3217

(57) ABSTRACT

A new method and apparatus is applied to manufacture boehmite and sol gel abrasive grain with greatly reduced raw material cost. The raw material starts from alumina trihydrate, which is transferred to highly dispersible alumina monohydrate under hydrothermal treatment in an agitated zirconium-steel or titanium-steel cladding plate high pressure reactor. Then the highly dispersed and deionized sol is converted to sintered high-density microcrystalline ceramic abrasive grain by sol-gel process.

### FIELD OF TECHNOLOGY

The invention relates to a new method and apparatus to manufacture boehmite and sol gel abrasive grain with greatly reduced raw material cost. The raw material starts from alumina trihydrate, which is transferred to highly dispersible alumina monohydrate under hydrothermal treatment in an agitated zirconium-steel or titanium-steel cladding plate high pressure reactor. Then the highly dispersed sol was converted to sintered high-density microcrystalline ceramic abrasive grain by invented or typical sol-gel process.

### DESCRIPTION OF RELATED ARTS

Since the early 1980's, sol-gel technology has been used to improve the performance of alumina abrasive and has had a major impact on both the coated and bonded abrasive business. Sol-gel processing permits the microstructure of the alumina to be controlled to a much greater extent than is possible by the fusion process. Consequently, the sol-gel abrasive has a crystal size several orders of magnitude smaller than that of the fused abrasive and exhibit a corresponding increase in toughness and abrasive performance.

During the last several decades, many efforts were put on that how to increase the grinding performance of sol-gel abrasive grain. These efforts included exploring additives such as modifiers and sintering aids, seeds and optimizing manufacturing process such as shaping and sintering techniques. These activities are described in patents such as U.S. Pat. No. 4,314,827, U.S. Pat. No. 4,518,397, U.S. Pat. No. 4,623,364, U.S. Pat. Nos. 4,770,671, 4,799,938, 4,848,041, U.S. Pat. No. 4,881,951, U.S. Pat. No. 4,964,883, U.S. Pat. No. 5,034,360, U.S. Pat. No. 5,090,968, U.S. Pat. No. 5,106,791, U.S. Pat. No. 5,190,567, U.S. Pat. No. 5,194,073, U.S. Pat. No. 5,227,104, U.S. Pat. No. 5,244,477, U.S. Pat. No. 5,431,704, U.S. Pat. No. 5,453,104, U.S. Pat. No. 5,489,204, U.S. Pat. No. 5,531,799, U.S. Pat. No. 5,660,604, U.S. Pat. No. 5,984,988, U.S. Pat. No. 6,258,141, U.S. Pat. No. 6,802,878, etc.

Few efforts were put on how to reduce the sol gel abrasive grain cost to make it suitable for mass production. The raw material of sol gel abrasive grain was high purity and highly dispersible boehmite (alumina monohydrate), which was obtained by hydrolysis of high purity aluminum alkoxides. The expensive raw material made the cost of sol gel abrasive grain very high and it was much more expensive than fused alumina abrasive, which limited its application in certain areas where its cost/benefit was justified. If cheap, high purity, highly dispersible and nano-sized boehmite is available, the sol gel abrasive grain cost will be reduced greatly.

U.S. Pat. No. 3,385,663 describes a process to convert alumina trihydrate which having a surface area of 5 to 50 square meters per gram to alumina monohydrate which having a surface area of more than 200 square meters per gram by autoclaving the alumina trihydrate at a temperature of 150 to 200 centigrade in the presence of water, a weak acid such as acetic acid, a water-soluble salt such as aluminum sulfate and optionally in the presence of trace amounts of mineral acid such as hydrochloric acid. The obtained alumina monohydrate is highly dispersible, but the concentration of acetic acid is relatively high and the added salt makes that the purity of the obtained alumina monohydrate is not acceptable for sol gel abrasive processing.

U.S. Pat. No. 3,954,957 describes a process to prepare alumina monohydrate crystals of uniform particle size in the range of 0.2 to 0.7 microns by grinding Bayer alumina trihydrate to a median particle size of 1-3 microns followed by digestion in the presence of a controlled amount of mineral acid such as nitric acid and hydrochloric acid. The particle size is relatively large and is not suitable for sol-gel abrasive processing. It is only suitable for pigments in paper, paint or ink.

U.S. Pat. No. 4,117,105 discloses a process for the preparation of finely divided dispersible alpha alumina monohydrate (boehmite) from alumina trihydrate. The alumina trihydrate is calcined thereby increasing surface area through a partial dehydration. The calcined intermediate is slurried in water and autoclaved to achieve crystallization and rehydration. Conventional drying methods are used to obtain the particles. The particle size of the product is much smaller than that of the starting material. But the particle size distribution is very wide (indicating by white dispersion), the alumina monohydrate obtained from this process is not suitable as the raw material for sol gel abrasive grain.

U.S. Pat. No. 4,344,928 describes a process to prepare aqueous suspensions of alumina particles, at least a portion of which comprising ultrafine boehmite by maintaining PH<9 aqueous formulation of poorly crystallized and/or amorphous activated alumina powder for such period of time as to effect at least partial transformation of such alumina powder into ultrafine powder. Because of the partial ultrafine boehmite transformation, the purity is not acceptable for sol gel abrasive process. Also, the beohmite prepared by this process is needle shaped and is not suitable for sol gel process.

U.S. Pat. No. 4,534,957 describes a process to convert hydragillite into boehmite by preparing a suspension of hydragillite in water in a proportion from 150 to 700 g/l of dry material expressed as Al₂O₃, subjecting it to heat treatment under pressure at a temperature of from 200 to 270 centigrade, the speed of the rise in temperature of said suspension being at least 1 centigrade/minute, and causing it to pass a period of time from 1 to 60 minutes in a holding zone at a temperature in the range of 200 to 270 centigrade. The boehmite produced has a granulometry which is at most identical to that of the initial hydragillite, and has a much lower content of alkaline material. But the boehmite particle from this process is too large; it's not acceptable for sol gel abrasive process.

U.S. Pat. No. 4,797,139 describes a method to produce microcrystalline boehmite suitable for conversion to anhydrous alumina products by hydrothermal treatment of precursor alumina raw material at controlled PH and in the presence of microcrystalline boehmite seed material. Reaction mix may include submicron seed material for seeding for later conversion of the microcrystalline boehmite to alpha alumina. Removal of metal cations by ion exchange is employed when high purity product is required. Other materials may be added to the reaction mix. U.S. Pat. Nos. 5,194,243 and 5,455,807 describes a similar process to U.S. Pat. No. 4,797,139. The common feature of these 3 patents is that they use microcrystalline boehmite as seed and nitric acid to facilitate the hydrothermal conversion of alumina tryhydrate to highly dispersible boehmite. But there is no evidence to show that this process is feasible for commercialization production since these patents were filed. Dispersal boehmite from Sasol is still the main raw material source for sol gel abrasive grain, because nitric acid is very corrosive to autoclave material at high temperature and pressures (as described in the patents, 170-200 centigrade and 8-15 kg/cm²), there is safety concerns regarding high pressure steam explosion caused by corrosion.

So, there is a need to design a feasible method and apparatus to produce cheap, high purity and highly dispersible alumina monohydrate without safety concerns. The feasible method and apparatus can reduce the raw material (alumina monohydrate) cost of sol gel abrasive grains greatly, and make it much more competitive than conventional fused alumina abrasive in view of benefit/cost in many grinding applications.

### SUMMARY OF THE INVENTION

It is an object of the invention to provide a new method and apparatus to manufacture boehmite and sol gel abrasive grain with greatly reduced raw material cost.

In this invention, the method and apparatus for producing alumina monohydrate and sol gel abrasive grain are described as follows:

The raw material starts from alumina trihydrate—Al(OH)₃, which is transferred to highly dispersible alumina monohydrate—AlOOH under hydrothermal treatment in an agitated zirconium-steel or titanium-steel cladding plate high pressure reactor. Then the highly dispersed and deionized sol is converted to sintered high-density microcrystalline ceramic abrasive grain by conventional or invented sol-gel process.

Zirconium and titanium are very corrosion-resistant to nitric acid at elevated temperatures and high pressures. For example, the corrosion tests in nitric acid at 190 centigrade show that titanium and zirconium are much better than type 304-347 stainless steel and nickel based alloy. The corrosion rate of zirconium in nitric acid is less than 0.13 mm/year, which make it suitable as autoclave material for hydrothermal process to convert cheap Al(OH)₃ to microcrystalline AlOOH as raw material for sol gel abrasive grain. Titanium is also a good option as autoclave material. Because the high cost of titanium and zirconium metal or alloy, zirconium-steel or titanium-steel cladding plate is a better choice as autoclave from cost point of view.

Since there are successful utilizations of zirconium-steel and titanium-steel cladding plate vessel or reactor in other industries to deal with chemicals containing nitric acid at high temperature and pressure. There is no safety concerns caused by corrosion.

### BRIEF DESCRIPTION OF THE DRAWINGS

FIG. 1 is zirconium-steel or titanium-steel cladding plate as autoclave material.

FIG. 2 is a zirconium-steel or titanium-steel cladding plate high pressure autoclave for alumina trihydrate hydrothermal treatment.

FIG. 3 is process for making high purity, highly dispersible boehmite.

FIG. 4 is process to make sol gel abrasive.

### DETAILED DESCRIPTION OF THE PREFERRED EMBODIMENT

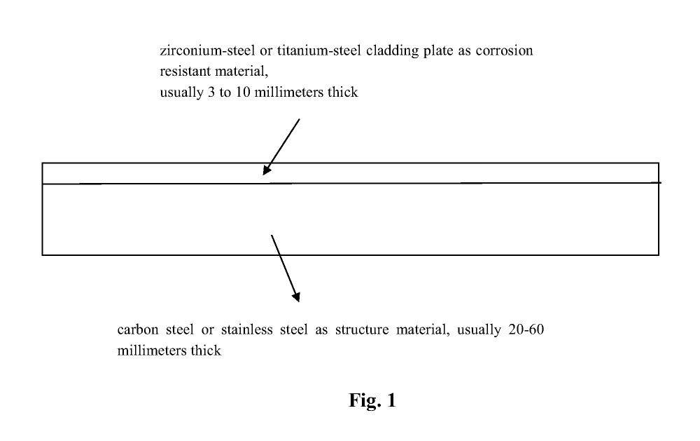

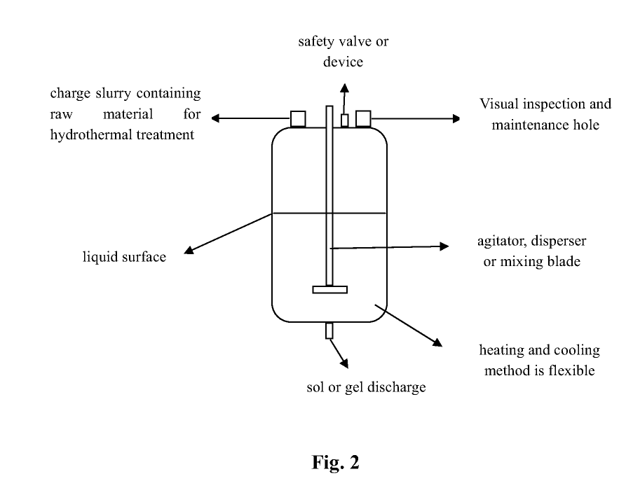

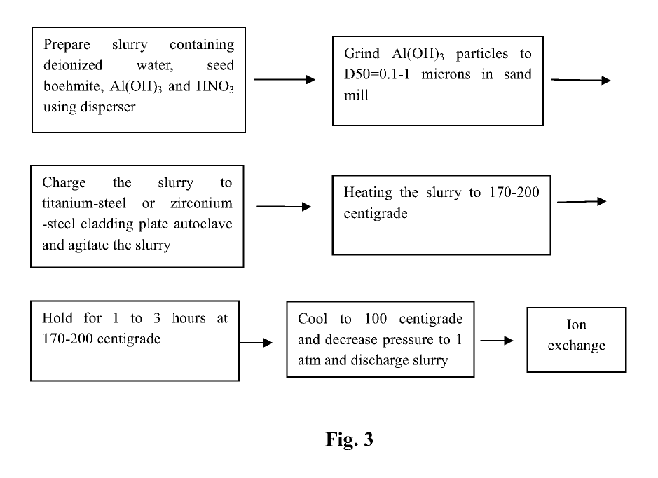

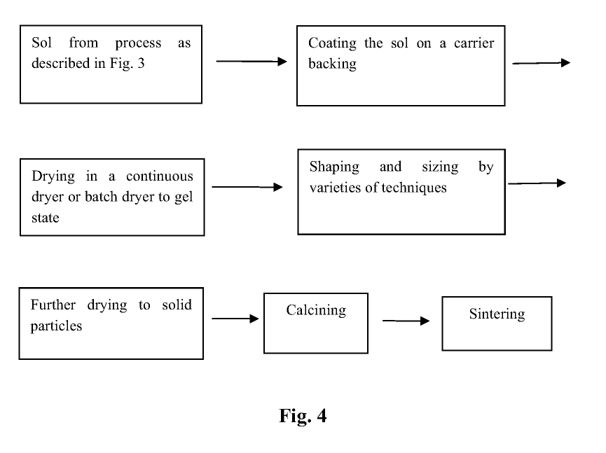

The invented apparatus to manufacture boehmite as raw material for sol gel abrasive grain is shown in FIGS. 1 and 2. The invented method or process to make high purity, highly dispersible boehmite is described in FIG. 3 and the invented method to make sol gel abrasive grain is described in FIG. 4.

In FIG. 1, the titanium-steel or zirconium-steel cladding plate is made by explosive welding techniques. Titanium or zirconium metal or alloy is used as corrosion-resistant material, its thickness is varied from 3 mm to 10 mm which depending on the cost and corrosion consideration. Carbon steel or stainless steel is used as structure material to make autoclave for hydrothermal treatment. Its thickness is varied from 20 to 60 mm, depending on the temperature & pressure in the vessel and the size of the vessel.

In FIG. 2, the apparatus or autoclave for hydrothermal treatment includes raw material charge port, finished goods discharge port, visual inspection/maintenance hole, safety valve or steam release device to avoid high pressure explosion caused by over-heating, dispersing/mixing blade to mix the alumina trihydrate slurry to avoid agglomeration and facilitate the conversion of Al(OH)₃ to microcrystalline AlOOH. Heating/cooling jacket or loop is not drawn in FIG. 2, the heating can be direct or indirect, by steam or heated oil or other methods. The cooling is circulated water cooling or by other means.

In FIG. 3, the method and process is shown, the detailed process steps are as follows:

(1) Slurry preparation: Al(OH)₃ particles, seeded microcrystalline boehmite or pseudo-boehmite, hot deionized water and HNO₃ are mixed to homogeneity by high-shear disperser. The solid content of Al(OH)₃ is from 10 to 30% and its particle size is D₅₀=1-2 micron which can be readily available from market, the added HNO₃ adjusts the slurry PH to 2-5. Low PH is better for hydrothermal conversion and particle size reduction but leads to gel in reactor easily. Optionally the Al(OH)₃ particles can also be calcined to increase surface area to facilitate the hydrothermal conversion.

(2) Size reduction of Al(OH)₃: the slurry is grinded in a sand mill which using small zirconia beads to a particle size of D₅₀=0.1-1 micron, the preferred range is D₅₀=0.1-0.5 micron. This size reduction process can facilitate the Al(OH)₃ converting to microcrystalline, nano-size dispersed boehmite particles with narrow particle size distribution.

(3) Hydrothermal treatment of slurry: the grinded slurry is charged to the zirconium-steel or titanium-steel cladding plate autoclave and agitated. Then increase the slurry temperature to 170-200 centigrade and hold for 1-3 hours to convert the Al(OH)₃ to AlOOH. The heating rate is not specified.

(4) Ion exchange: After hydrothermal conversion, the discharged boehmite dispersion is deionized to reduce alkaline oxide to get high purity products by electrodialysis or ion exchange resin or other methods.

In FIG. 4, process to make sol gel abrasive grain use invented boehmite is described. The assignee filed another patent application, there is no need to repeat the details.

The above-mentioned hydrothermal process is conducted in a 10 liter titanium-steel cladding plate autoclave, the obtained boehmite is seeded with 1% nano-sized alpha alumina, gelled, calcined, and sintered to abrasive grain, the Vickers hardness is 20 GPa at 100 gram load and the density is 3.88, it is suitable for abrasive applications.

1. A process to make highly dispersible boehmite suitable as raw material of sol gel abrasive grain, characterized in that, the boehmite is made by converting alumina trihydrate to boehmite in an agitated zirconium-steel or titanium-steel cladding plate vessel or pure titanium vessel.

2. A sol gel abrasive grain with various shapes and sizes, characterized in that, the raw material boehmite is prepared as described in claim 1.

3. A sintered abrasive grain with various shapes and sizes, characterized in that, the alpha alumina or other form of alumina is derived from the boehmite prepared as described in claim 1.

4. A coated abrasive product, characterized in that, its grain is made as described in one of claims 2 & 3.

5. A bonded abrasive product, characterized in that, its grain is made as described in one of claims 2 & 3.

6. An autoclave or a reactor or vessel, characterized in that, it is made from titanium-steel or zirconium-steel cladding plate or pure titanium and used as hydrothermal treatment in sol gel abrasive grain manufacturing process.
